(19) United States
(12) Patent Application Publication
(10) Pub. No.: US 2004/0060462 A1
(43) Pub. Date: Apr. 1, 2004

(54) Methods and devices for operating a pressure unit

(76) Inventors: Erhard Herbert Glockner, Eibelstadt (DE); Bernd Kurt Masuch, Kurnach (DE)

Correspondence Address: Douglas R Hancom, Jones Tullar & Cooper, Eads Station, PO Box 2266, Arlington, VA, 22202, US

(21) Appl. No.: 10/471,292

(22) PCT Filed: Mar. 6, 2002
(86) PCT No.: PCT/DE02/00805

(30) Foreign Application Priority Data
Mar. 20, 2001 (DE) 101 13 338.3

(51) Int. Cl. B41F 13/004

(52) U.S. Cl. 101/217

(57) ABSTRACT

The invention relates to a method for operating a pressure unit comprising at least one counter-pressure cylinder (03) and a transfer cylinder (04) forming a pressure point therewith. The counter-pressure cylinder is mechanically actuated by means of a first drive motor (06) independently from the transfer cylinder. In a pressure-on-position, the counter-pressure cylinder is adjusted as a guide variable in relation to the power of the motor which drives the cylinder.

The invention relates to methods and devices for operating a printing unit in accordance with the preamble of claims 1, 3, 5 or 12 and 13, 14 or 22.

In the course of driving cylinders or groups of cylinders by means of separate drive mechanisms, for example in satellite printing units, process-related unwinding differences between the pairs of cylinders can occur. These are dependent on the contact pressure, the number of active printing positions, the thickness of the dressings, the type, or even the producer of the dressing itself, whether the friction gear is embodied without or with bearer rings, on the radii of the bearer rings, or on the radius ratios of the friction gear as a whole.

This can result in part in considerable and, with changing conditions, in considerably varying output effects between the cylinders, or groups of cylinders. This is undesirable, since it results in asymmetries in the output layout, in different outputs, depending on the conditions and modes of operation, or even in overloads of the motors and regulators.

Cylinders of a rotary printing press with bearing rings are known from DE 195 01 243 A1, wherein the bearing rings of the satellite cylinder are rotatably seated for the purpose of reducing the output transfer.

In WO 00/41887 A1, a compensating friction gear in the form of bearing rings of reversed radius ratios is superimposed on a friction gear with cylinders which are in process-related frictional contact. The normal force between the cylinders placed against each other is set in such a way that a value of a difference between the power consumption of the motors driving the cylinders is minimal.

DE 195 27 199 A1 shows a drive mechanism for a printing unit, wherein a forme cylinder can be driven at varying circumferential speeds as a function of a contact of the printing forme with a counter-pressure cylinder. A circumferential speed which differs from that of the counter-pressure cylinder occurs in a phase of the cylinder rotation in which there is no printing contact between the forme and the counter-pressure cylinder.

The object of the invention is based on providing methods and devices for operating a printing unit.

In accordance with the invention, this object is attained by means of the characteristics of claims 1, 3, 5 or 12, and 13, 14 or 22.

The advantages which can be obtained by means of the invention consist in particular in that a sufficiently good unwinding of the printing cylinders takes place, which is to a large extent a function of the contact pressure and/or the number of the active printing positions, the thickness of the dressing and/or the type or the manufacturer of the dressing. With changing configurations of the printing positions and/or the excerpts, in particular the printing blankets on the transfer cylinders, the print quality is not, or only slightly, reduced.

In principle it its possible to determine a suitable defined difference in the circumferential speeds at different modes of operation and/or for dressings, which can be stored in a memory, for example, and, depending on the mode of operation/or dressing, can be forced on and maintained during production.

A minimization of the fluctuation width of the motive or generative output of the drive motor takes place in an advantageous manner by means of the regulation in accordance with the invention of the leading or trailing of the rpm, or of the circumferential speed, of at least one of the cylinders in respect to at least one oppositely located cooperating second cylinder as a function of the output of the drive motor, either produced or received, via the friction gear.

The above mentioned regulation can be employed in particular in connection with printing units in which several transfer cylinders form printing positions with so-called satellite cylinders, such as in 5-cylinder printing units, 9-cylinder or 10-cylinder satellite printing units.

The employment of the said regulation is particularly advantageous for printing units with cylinders which roll off one another without bearing rings. The satellite cylinder is operated in a leading or trailing manner, which is a function of the power consumption, or output, of the drive motor assigned to it, in respect to the transfer cylinder cooperating with it. In case of cylinders without bearing rings, the output is transferred exclusively by means of the cylinders themselves rolling off on each other. In case of a change of the configuration, in particular when changing the dressings on the transfer cylinders, for example of printing blankets with different conveying properties—co-called negatively, neutrally or positively conveying printing blankets—, the required generative or motive output at the satellite cylinder is maintained within narrow limits by means of the regulation. In this way an excess size and/or the danger of overloading regulating device and drive motors is reduced.

However, the regulation is also suitable for printing units with bearing rings which roll off on each other, wherein in this case a slippage between the bearing rings within defined limits (see below) is permitted.

In order to maintain a desired print quality, selectable lower or upper limits of the deviation of the number of revolutions, or the circumferential speed, from the circumferential speed of the cooperating transfer cylinders are not downwardly or upwardly exceeded, simultaneously with the reduction of the generative or motive output at the satellite cylinder. The satellite cylinder is driven within these limits at its minimum absolute output (generative or motive). These limits can each be variously selected in connection with various materials to be imprinted, various printing methods and various demands made on quality, and lie, for example for newspaper printing, at a deviation of ±0.01% to ±0.05% from the production, or circumferential speed of the cooperating cylinders.

This regulation is advantageous for printing units whose cylinders are driven in groups or individually by several mechanically unconnected drive motors; for example for 9- or 10-cylinder satellite printing units with one drive motor each per cylinder, for 9- or 10-cylinder satellite printing units with one drive motor each per forme cylinder-transfer cylinder pair and the satellite cylinder(s), or also for 9- or 10-cylinder satellite printing units with one drive motor each for each group of forme cylinder-transfer cylinder pairs.

Exemplary embodiments of the invention are represented in the drawings and will be described in greater detail in what follows.

Shown are in:

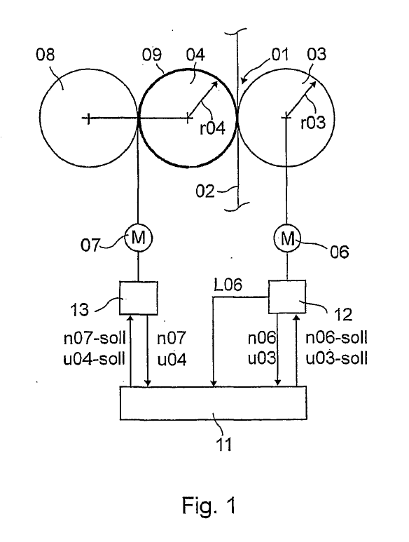

FIG. 1, a schematic representation of cooperating cylinders of a rotary printing press,

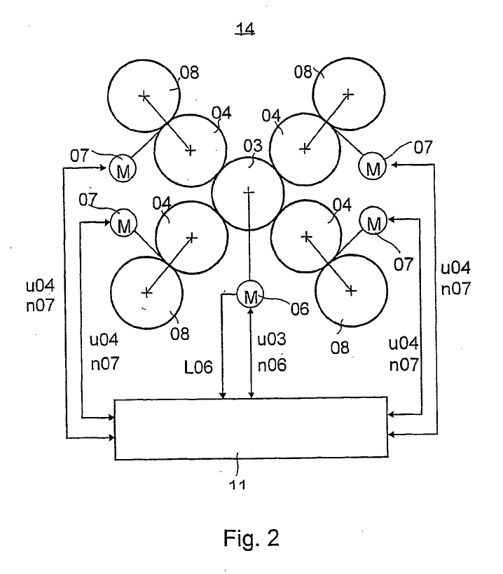

FIG. 2, a schematic representation of a 9-cylinder satellite printing unit,

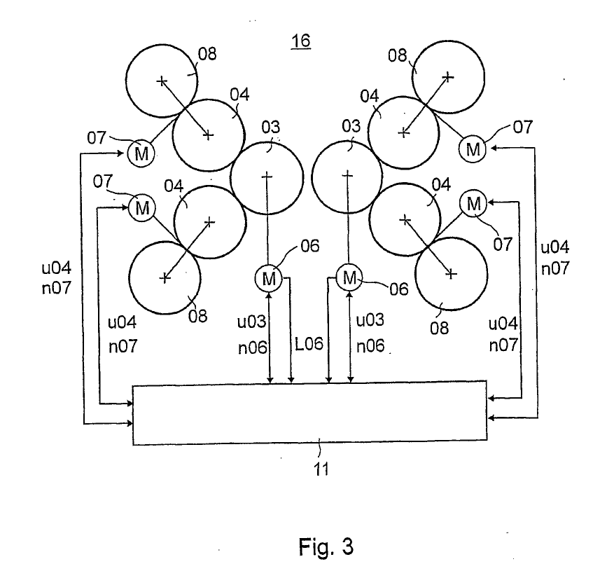

FIG. 3, a schematic representation of a 10-cylinder satellite printing unit.

A rotary printing press has a printing position 01 with two cylinders 03, 04, which in a print-on position work together via a web 02, for example a web 02 of material to be imprinted, in particular a paper web 02. In the example, the cylinders 03, 04 are embodied without bearing rings and constitute a friction bearing by means of their jacket surfaces which roll off on each other. The first cylinder 03 is embodied as a counter-pressure cylinder 03, for example as a steel cylinder 03, and during letterpress or flexographic printing it can be driven directly or indirectly by a drive motor 06, but independently of the second cylinder 04, for example a transfer cylinder 04, or a printing block cylinder 04.

The second cylinder 04, for example embodied as a transfer cylinder 04, can also be driven directly or indirectly, for example via a gear, not represented, for example a gear wheel, toothed belt or friction gear, by means of a second drive motor 07. The transfer cylinder 04 can be driven individually, or together with a third cylinder 08 working together with it, for example a forme cylinder 08, or an inking or dampening unit, not represented. In the example, the transfer cylinder 04 can be driven together with the forme cylinder 08 by means of the drive motor 07 (schematically in FIG. 1).

On its jacket, the second cylinder 04 has a dressing 09, for example a printing blanket 09, a rubber blanket 09 or a printing block 09, by means of which the ink is applied to the paper web 02.

In the example, the counter-pressure cylinder 03 is embodied with a radius r03, and the transfer cylinder 04 with a radius r04, as cylinders 03, 04 of a so-called double circumference, i.e. with a circumference corresponding to two vertical or two horizontal printed pages, for example newspaper pages. In order to counteract a distortion or displacement of the printed image, for example caused by flexing of the dressing 09, the radius r03 of the counter-pressure cylinder 03 is designed to be larger by 0.2 to 1 per thousand than the radius r04 of the transfer cylinder 04.

However, cylinders 03, 04 can be embodied with single circumference or, for example, the transfer cylinder 04 with a single, and the counter-pressure cylinder 03 with double circumference. The width of the cylinder 03, 04, 08 can be single, double, triple or quadruple.

In customary methods, the drive of the cooperating cylinders 03, 04, 08 takes place in such a way that the circumferential speeds u03, u04 of the cylinders 03, 04, 08 are almost identical. As a rule, when using several drive motors 07, 06, which are not mechanically coupled with each other, this is accomplished by means of an rpm regulation, and via an “electronic shaft”, i.e. by means of electrical synchronization.

However, a strong mechanical coupling takes place in particular in connection with cylinders 03, 04 without bearing rings, which is greatly dependent on the type of the dressings 09, their properties, and on the number of cylinders 04 placed against a counter-pressure cylinder 03. For example, rubber blankets 09 of different types or from different producers show very different conveying properties when rolling off on the jacket of the counter-pressure cylinder 03.

At the same circumferential speed u04, u03, or rpm n07, n08, negatively conveying rubber blankets 09 on the transfer cylinder 04 have a tendency of braking the counter-pressure cylinder 03, while positively conveying rubber blankets 09 accelerate the counter-pressure cylinder 03 in the direction of rotation. In the first case, the operation of the drive motor 08 for the counter-pressure cylinder 03 requires an increased motor output, and in the second case an increased generating output.

A regulation to identical circumferential speeds u03, u04, or rpm n06, n07, or to a fixed relative angle of rotation position, does not solve the problem if conditions change.

As schematically represented in FIG. 1, the circumferential speeds u03, u04 of the cylinders 03, 04, or the rpm n06, n07 of their drive motors 06, 07, are picked up and provided to a control device 11. Detection can take place via separate angle encoders, encoders internal to the motor, or in any other way. In addition, at least the output L06 of the drive motor 06 at the counter-pressure cylinder 03 is picked up and provided to the control device 11.

The control device 11 can be embodied in various ways, so that for example each one of the drive motors 06, 07 has its own drive control 12, 13, which is assigned a desired value n06-soll, n07-soll for a circumferential speed u03, u04 at the cylinders 03, 04, or rpm n06, n07 corresponding to the cylinder 08, via the control device 11. However, the respective drive control can also be integrated into the control device 11. The evaluation of the rpm n06, n07 and the assignment of desired values n06-soll, n07-soll can take place by means of software in a computer, in the control console, or in a module of an SPS by means of programming or hardware.

At the start of production, the drive motors 06, 07 are regulated to desired values n06-soll, n07-soll of their rpm by means of feedback of the actual values of the rpm n06, n07 as the command variable in such a way that the circumferential speeds u03, u04 of the cooperating cylinder 03, 04 are almost identical.

With print-on, i.e. the two cylinders 03, 04 are in printing contact with each other, the circumferential speed u03 of the counter-pressure cylinder 03 is varied in such a way that the size of the output L06 of the drive motor 06 becomes less and, in the ideal case, assumes a minimum. A change of the relative circumferential speeds u03, 04, or changes in the relative angular position, are intentionally permitted. This is independent of the passage of a printed image through the nip location, instead, it generally takes place during printing contact. Now the output L06 is the command variable for regulating the circumferential speed u03, or the rpm n06. Based on the output L06 as the command variable, a changed desired value of the circumferential speed u03-soll, or the rpm n06-soll, for example, can be established and assigned.

In principle it is also possible to store suitable differences of the circumferential speeds u03, u04 for various operational situations and/or different dressings, which are then maintained by means of drive motors 06, 07, which are angle- or rpm-controlled.

However, the variation of the rpm n06 takes place under the condition that the circumferential speed u03 lies maximally below the circumferential speed u04 of the cooperatively acting cylinder 04 (trailing), or of the production speed uₚ, by a deviation Delta u1, for example Delta u1=−0.01% to −0.05%, and above the circumferential speed u04 of the cooperatively acting cylinder 04 (leading), or the production speed uₚ, by maximally Delta u2, for example +0.01 to +0.05%. For this reason, monitoring of the rpm n06, or the circumferential speed u03, is continued and compared with the rpm n07, or the circumferential speed u04 of the second cylinder 04. This is monitored to determine whether the relative deviation Delta u of the circumferential speed u03 from the circumferential speed 04 still lies within the above mentioned interval.

The following applies regarding the regulation during production and/or in the print-on position:

$${\vert L06 ( Δ u ) \vert}^{ l} = {Min}_{ local} \underline{for all} \{ Δ u \vert Δ u1 \leq \frac{Δ u}{u04} \leq Δ u2 \}$$

wherein Delta u=(u03-u04).

Thus the regulation of the drive motor 06 to obtain identical, constant rpm n06 or n07, or identical circumferential speeds u03 and u04 does not primarily take place. Regulation follows an rpm n06 along a drop in the output L06 as a function of the deviation Delta u between the resulting circumferential speed u03 and the circumferential speed u04, or of the production speed uₚ (for 04=uₚ) of the cooperatively acting cylinder 04.

A relative minimum for the generative or motive output L06 can lie in the rpm range permitted for the variation, which corresponds to the said interval (Delta u1, Delta u2) for the permissible relative deviation from the circumferential speeds u03, u04. But possibly there can also only be a monotone dropping or rising dependency in the permitted interval (Delta u1, Delta u2) between the output LOG and the deviation from the circumferential speed u03, u04, so that the rpm n06, and therefore the circumferential speed u06 in the respective operational state takes on the maximally permissible upward or downward deviation Delta u. In this way the generative, or motive output L06 in the permitted interval is minimized for the deviation Delta u in this case, too. When the limit value Delta u1, Delta u2 has been reached, regulation of the drive of the first cylinder 03 in this case takes place by means of the rpm n06, or the circumferential speed u03 as the command variable. The rpm n06 is maintained at this limit value Delta u1, Delta u2 as long as it is not possible to leave the limit value Delta u1, Delta u2 in the permitted direction because of new conditions, for example in the dependency of the output 06.

If, for example, the transfer cylinder 04 has a dressing 09 which is negatively conveying, i.e. it “brakes” the counter-pressure cylinder 03, the motive output L06 at the drive motor 06 is increased after reaching the circumferential speed u03, u04, or of the production speed uₚ of the cylinders 03, 04, and the print-on position. Now the rpm n06, or the circumferential speed u03 of the counter-pressure cylinder 03 is reduced until either a local minimum or the lower limit value Delta u1 for the deviation Delta u from the circumferential speed u04 of the second cylinder 04, or of the production speed uₚ, has been reached. In this case an increase of the rpm n06 would lead to an increased absorption of motive output L06.

In the reverse case, when using a positively conveying dressing 09, the drive motor 09 is provided with an additional torque via the frictional gearing of the cylinder 03, 04 following the placement into the print-on position, and in case of a regulation to identical constant circumferential speeds u03, u04, would need an increased generative output L06. Now the rpm n06, or the circumferential speed u03 of the counter-pressure cylinder is increased until either a local minimum or the upper limit value Delta u2 for the deviation Delta u from the circumferential speed u04 of the second cylinder 04, or of the production speed uₚ, has been reached. In this case a decrease of the rpm n06 would lead to a further increased absorption of generative output L06.

Such a regulation in respect to the minimal motive, or generative output L06 can be embodied so it is preset manually or, in an advantageous embodiment, self-adaptive. The limit values Delta u1, Delta u2 are a function of the printing press, the material to be imprinted, the demands made on the printing result and the configuration of the printing press, and can already be preset in the form of programs fixedly stored in the control device 11 and possibly selectable, or via an input arrangement.

With newspaper printing on appropriate paper, the lower limit value Delta u1 (trailing), as well as the upper limit value Delta u2 (leading), lie advantageously at ±0.01 to ±0.03%, in particular at ±0.02%, so that the following applies:

$${\vert L06 ( Δ u ) \vert}^{ l} = {Min}_{ local} \underline{ for all} \{ Δ u \vert \vert \frac{Δ u}{u04} \vert \leq 0 , 2 \% \}$$

wherein: Delta u=(u03-u04).

In actual operations, the determination and regulation toward defined rpm n06, n07, or circumferential speeds u03, u04, also takes place by means of angular positions of the cylinders 03, 04, or of the drive motors 06, 07, and/or their chronological changes. In what was said before and what follows, the determination and regulation of the rpm n06, n07, or circumferential speeds u03, u04, should also be understood in the sense of determining the angular positions and a regulation in respect to the angular positions and/or their chronological changes (angular velocities).

A regulation in respect to identical circumferential speeds u03, u04 of two cooperating cylinders 03, 04 then corresponds in the case of cylinders 03, 04 of equal circumference to the correspondingly identical changes in the angular positions (of the cylinders 03, 04 and/or possibly of the drive motors 06, 07). For different radii r03, r04 of the cylinders 03, 04 it is necessary in the course of the regulation to take into consideration the chronological changes of the angular positions, or of the angular positions themselves, in respect to the radius conditions.

For a regulation wherein a relative deviation Delta u from the circumferential speeds u03, u04 of the cylinders 03, 04 is permissible, or is intentionally caused, in this mode of operation the regulation to identical angular positions and/or their chronological changes is suspended, at least for the drive mechanism of one of the cylinders 03, 04. The respectively other cylinder 03, 04, however, can be synchronized in respect to further cylinders, printing units and/or units of the printing press, i.e. regulated to identical circumferential speeds u03, u04, or corresponding angular positions, to maintaining a defined relative angular position, and/or identical chronological changes in the angular positions.

A 9-cylinder satellite printing unit 14 with four possible printing positions 01 is represented in FIG. 2, at which the paper web 02 can be imprinted in the print-on position (the printing positions 01 and the paper web 02, as well as dressings 09, are not explicitly represented in FIGS. 2 and 3). In contrast to FIG. 1, only four transfer cylinders 04 can be placed against a counter-pressure cylinder 03 embodied as a satellite cylinder 03. The transfer cylinders 04 and the cooperating forme cylinders 08 can each be driven in pairs by means of the drive motor 07. In contrast to FIG. 1, no drive controls 12, 13 have been represented between the drive motors 06, 07 and the control device 11.

Depending on the number of transfer cylinders 04 in contact, on the type of the dressings 09 (positively, negatively, neutrally conveying), and the conveying behavior of the paper type used in the paper web 02, with the satellite cylinder 03 set to a constant circumferential speed u03, or rpm n06, the generative or motive output L06 at the drive motor 06 can again fluctuate considerably.

The drive motors 07 of the transfer cylinders 04 which are in the print-on position, are regulated to an rpm n07-soll via the output supply by means of the actual value of the rpm n07 as the command variable, which corresponds, for example, to the selected production speed uₚ, or the circumferential speed u04-soll of the transfer cylinders 04.

The drive motor 06 of the satellite cylinder 03 is initially, in particular prior to the print-on position, regulated to the same circumferential speed u03=u04, for example the production speed uₚ, by means of the preset desired value n06-soll.

After one or several transfer cylinders 04 are in the print-on position, the supply of the output L06 is no longer regulated in respect to a rpm n06-soll corresponding to the circumferential speed u04, or the circumferential speed u03-soll, but in the reverse manner the rpm n06, or the circumferential speed u03 is regulated by means of the output L06 as the command variable in respect to a minimal motive or generative output L06 of the drive motor 06. The desired value u03-soll at the satellite cylinder 03 is changed, for example, by a relative deviation Delta u. The marginal condition must again be met, that the deviation Delta u of the circumferential speed u03 of the satellite cylinder 03 from the circumferential speed u04, or the production speed uₚ, is not permitted to downwardly or upwardly exceed a lower limit value Delta u1 (trailing) and an upper limit value Delta u2 (leading), for example ±0.02% of the production speed uₚ.

If, as represented in FIG. 3, the two satellite cylinders 03 of a 10-cylinder satellite printing unit 16 are each driven by means of their own drive motors 06, the regulation regarding the minimum of the output L06 of each drive motor 06 can take place individually.

The regulation can also be used for larger printing units, or printing unit systems, for example for two stacked 9-cylinder satellite printing units 14, or also for stacked 10-cylinder satellite printing units 16. With such arrangements, the paper web 02 can be printed in four colors on both sides or, for example, in two colors on both sides with full imprinter functionality.

If the respectively cooperating transfer and forme cylinders 04, 08 are not driven in pairs, but each one by means of its own drive motor 07, the regulation of the drive motors 07 for the forme cylinders 08 and the transfer cylinders 04 in respect to their circumferential speeds u04-soll, u08-soll, or the rpm n07-soll for the drive motor 07, is performed in accordance with the above exemplary embodiments for the drive motors 07.

The regulation of a drive motor 06, 07 of the cylinders 03, 04 by means of the output L06 as the command variable is not limited to the counter-pressure or satellite cylinder 03 represented in the examples. It is also possible in the reverse way during production to perform a regulation of the satellite cylinders 03 by means of the actual value of the rpm n06, or the circumferential speed u03, as the command variable to a constant rpm n06-soll, or a constant circumferential speed u03-soll, while the cooperating transfer cylinder(s) 04 is regulated to a minimum output in the respective interval by means of an output, not represented, as the command variable.

In the case of respectively individually driven cylinders 03, 04, 08, the regulation of the drive motor 06 takes place in a way wherein it substantially absorbs the same output L06 as the drive motor 07 of the cylinder 04, which in this case is individually driven. For this purpose a deviation of the circumferential speed u03, u04 within the stated limits is intentionally accepted.

A high generative output L06 in particular is avoided by means of the described regulation, without the quality of the product lying outside a tolerable range. This applies to the use of differently conveying rubber blankets 09.

List of Reference Symbols

01 Printing position

02 Web, web of material to be imprinted, paper web

03 Cylinder, first, counter-pressure cylinder, steel cylinder, satellite cylinder

04 Cylinder, second, transfer cylinder, printing block cylinder

05 -

06 Drive motor, first

07 Drive motor, second

08 Cylinder, third, forme cylinder

09 Dressing, printing blanket, rubber blanket, printing block

10 -

11 Control device

12 Drive control

13 Drive control

14 9-cylinder satellite printing unit

15 -

16 10-cylinder satellite printing unit

L06 Output

n06 Rpm (06)

n07 Rpm (07)

n06-soll Desired value, rpm

n07-soll Desired value, rpm

r03 Radius (03)

r04 Radius (04)

u03 Circumferential speed (03)

u04 Circumferential speed (04)

u03-soll Desired value, circumferential speed

u04-soll Desired value, circumferential speed

uₚ Production speed

Delta u Deviation (u03-u04)

Delta u1 Limit value, first, lower

Delta u2 Limit value, second, upper

1. A method for driving a printing unit, having at least one counter-pressure cylinder (03) and a transfer cylinder (04) constituting a printing position (01) together with the former, characterized in that the two cooperating cylinders (03, 04), which are in contact with each other, are driven at different circumferential speeds (u03, u04) during production.

2. The method in accordance with claim 1, characterized in that the counter-pressure cylinder (03) is driven by means of a first drive motor (06) independently of the transfer cylinder (04), and that in the print-on position the counter-pressure cylinder (03) is regulated as a function of an absorbed output (L06) of the drive motor (06) driving the counter-pressure cylinder (03).

3. A method for driving a printing unit, having at least one counter-pressure cylinder (03) and a transfer cylinder (04) constituting a printing position (01) together with the former, wherein the counter-pressure cylinder (03) is driven by means of a first drive motor (06) mechanically independently of the transfer cylinder (04), characterized in that in the print-on position the counter-pressure cylinder (03), which is in printing contact with the transfer cylinder (04), is regulated as a function of an absorbed output (L06) of the drive motor (06) driving the counter-pressure cylinder (03).

4. The method in accordance with claim 2 or 3, characterized in that, as a function of the electrical output (L06) of the drive motor (06), a circumferential speed (u03) of the counter-pressure cylinder (03) is changed in relation to the circumferential speed (u04) of the transfer cylinder (04).

5. A method for driving a printing unit, having at least one counter-pressure cylinder (03) and a transfer cylinder (04) constituting a printing position (01) together with the former, wherein the counter-pressure cylinder (03) is driven by means of a first drive motor (06) mechanically independently of the transfer cylinder (04), characterized in that during the printing contact between the two cylinders (03, 04), a circumferential speed (u03) of the counter-pressure cylinder (03) is changed in relation to the circumferential speed (u04) of the transfer cylinder (04) as a function of an electrical output (L06) of the first drive motor (06).

6. The method in accordance with claim 2, 3 or 5, characterized in that the regulation of the first drive motor (06) takes place in view of an electrical output (L06) whose value drops, and that simultaneously a relative deviation (Delta u) from the circumferential speeds (u03, u04) of the cylinders (03, 04), or of the rpm (n06, n07) of the drive motors (06, 07) lies within a permissible interval.

7. The method in accordance with claim 6, characterized in that the regulation of the drive motor (06) takes place in view of an output (L06) whose value is minimal and lies within the interval permissible for the relative deviation (delta u) during a variation of the circumferential speed (u03, u04) of one of the cylinders (03, 04).

8. The method in accordance with claim 1, 3 or 5, characterized in that the second cylinder (04) is driven by means of a second drive motor (07), and that the transfer cylinder (04) is regulated in view of a presettable rpm (n07-soll) of the second drive motor (07), or a presettable circumferential speed (u04-soll, uₚ) of the transfer cylinder (04).

9. The method in accordance with claim 6, characterized in that the permissible relative deviation (Delta u) from the circumferential speeds is formed by a first limit value (Delta u1) in the direction toward lower circumferential speeds (u03) of the counter-pressure cylinder (03) in comparison with the transfer cylinder (04), and by a second limit value (Delta u2) in the direction toward greater circumferential speeds (u03) of the counter-pressure cylinder (03) in comparison with the transfer cylinder (04).

10. The method in accordance with claim 9, characterized in that the first limit value (Delta u1) is formed by a maximum deviation (Delta u) of −0.05 to −0.01%, in particular approximately −0.02%.

11. The method in accordance with claim 9, characterized in that the second limit value (Delta u2) is formed by a maximum deviation (Delta u) of +0.05 to +0.01%, in particular approximately +0.02%.

12. A method for driving a printing unit, having at least one counter-pressure cylinder (03) and a transfer cylinder (04) constituting a printing position (01) together with the former, wherein initially, as a function of a mode of operation and/or a dressing on at least one of the cooperating cylinders (03, 04), a deviation (Delta u), which is suitable in view of the production, from the circumferential speeds of the two cylinders (03, 04) is determined and derived, and wherein during production the drive mechanism of the cylinders (03, 04) is charged with the deviation (Delta u) corresponding to the operational situation and/or the dressing.

13. A device for driving a printing unit, having at least one counter-pressure cylinder (03) and a transfer cylinder (04) constituting a printing position (01) together with the former, wherein the counter-pressure cylinder (03) can be driven mechanically independently from the transfer cylinder (04) by means of a first drive motor (06), characterized in that during the printing contact between the two cylinders (03, 04), a circumferential speed (u03) of the counter-pressure cylinder (03) can be changed in relation to the circumferential speed (u04) of the transfer cylinder (04) as a function of an electrical output (L06) of the first drive motor (06).

14. A device for driving a printing unit, having at least one counter-pressure cylinder (03) and a transfer cylinder (04) constituting a printing position (01) together with the former, wherein the counter-pressure cylinder (03) can be driven mechanically independently from the transfer cylinder (04) by means of a first drive motor (06), characterized in that during the printing contact between the two cylinders (03, 04), a circumferential speed (u03) of the counter-pressure cylinder (03) can be changed in relation to the circumferential speed (u04) of the transfer cylinder (04) as the command variable as a function of an electrical output (L06) of the first drive motor (06).

15. The device in accordance with claim 14, characterized in that in the print-on position a circumferential speed (u03) of the counter-pressure cylinder (03) can be changed in relation to a circumferential speed (u04) of the transfer cylinder (04) as a function of the electrical output (L06) of the drive motor (06).

16. The device in accordance with claim 13 or 14, characterized in that the first drive motor (06) can be regulated in view of an electrical output (L06) whose value drops.

17. The device in accordance with claim 16, characterized in that the first drive motor (06) can be regulated in view of an electrical output (L06) whose value is minimal.

18. The device in accordance with claim 16, characterized in that a relative deviation (Delta u) from the circumferential speeds (u03, u04) of the cylinders (03, 04), or of the rpm (n06, n07) of the drive motors (06, 07) simultaneously lie within a permissible interval.

19. The device in accordance with claim 16, characterized in that the interval for the permissible relative deviation (Delta u) from the circumferential speeds (u03, u04) is formed by means of a first limit value (Delta u1) in the direction of slower circumferential speeds (u03) of the counter-pressure cylinder (03) in comparison to the transfer cylinder (04), and by means of second limit value (Delta u2) in the direction of greater circumferential speeds (u03) of the counter-pressure cylinder (03) in comparison to the transfer cylinder (04).

20. The device in accordance with claim 19, characterized in that the first limit value (Delta u1) is formed by a maximum deviation (Delta u) of −0.05 to −0.01%, in particular approximately −0.02%.

21. The device in accordance with claim 19, characterized in that the second limit value (Delta u2) is formed by a maximum deviation (Delta u) of +0.05 to +0.01%, in particular approximately +0.02%.

22. A device for driving a printing unit, having at least one counter-pressure cylinder (03) and a transfer cylinder (04) constituting a printing position (01) together with the former, wherein the counter-pressure cylinder (03) can be driven mechanically independently from the transfer cylinder (04) by means of a first drive motor (06), characterized in that in the print-on position at least one of the satellite cylinders (03) can be regulated in view of an electrical output (L03) whose value is dropping, of the drive motor (06) at variable circumferential speed (u03), and one or several of the transfer cylinders (04) can be regulated in view of a presettable circumferential speed (u04-soll, uₚ).

23. The device in accordance with claim 22, characterized in that a relative deviation (Delta u) from the circumferential speeds (u03, u04) does not fall below a first limit value (Delta u1), in particular wherein (Delta u1) is approximately −0.02%, toward slower circumferential speeds (u03) of the counter-pressure cylinder (03) in comparison to the transfer cylinder (04), and does not exceed a second limit value (Delta u2), in particular wherein (Delta u2) is approximately +0.02%, toward higher circumferential speeds (u03) of the counter-pressure cylinder (03) in comparison to the transfer cylinder (04).
